(19) United States
(12) Patent Application Publication
(10) Pub. No.: US 2020/0284288 A1
(43) Pub. Date: Sep. 10, 2020

(54) PANEL NUT WITH IMPROVED RETAINING METHOD

(71) Applicant: Production Spring, LLC, Troy, MI (US)

(72) Inventors: Lawrence Johnson, Taylor, MI (US); Allan Anthony, Kimball, MI (US); Arturo Spaccarotelli, Saint Clair Shores, MI (US); Eric Webb, New Baltimore, MI (US); Christopher N. Brodzik, Roseville, MI (US)

(73) Assignee: Production Spring, LLC, Troy, MI (US)

(21) Appl. No.: 16/809,723

(22) Filed: Mar. 5, 2020

Related U.S. Application Data
(60) Provisional application No. 62/815,238, filed on Mar. 7, 2019.

(51) Int. Cl. F16B 37/04

(52) U.S. Cl. CPC F16B 37/043

(57) ABSTRACT

A panel nut including an upper arm, a lower arm, and at least one transition arm extending between the upper arm and the lower arm to allow the upper arm to elastically deflect with respect to the lower arm is disclosed. The upper arm includes a forward flange, an inner member having a first end and an opposite second end, an outer member having a first end and an opposite second end, and a thread housing formed on the inner member. The lower arm includes a forward edge, an opposite rear end, a retainer hinge, and a retainer extending from the retainer hinge toward the rear end and toward the upper arm. The retainer is configured to elastically deflect between an unstressed position and a stressed position to be received within the thread housing when in the unstressed position.

### CROSS-REFERENCE TO RELATED APPLICATION

This application claims priority to U.S. Provisional Application No. 62/815,238, filed Mar. 7, 2019, which is hereby incorporated by reference in its entirety including the drawings.

### TECHNICAL FIELD

This present specification generally relates to fasteners, and more specifically to flexible nuts that are flexibly retained on at least one panel.

### BACKGROUND

Fasteners are used in a variety of applications to help secure at least two objects to one another and commonly used in manufacturing. Panel nuts are an example of these types of fasteners and are typically used as an inexpensive alternative to a conventional hex nuts when threaded loads are minimal or when space is limited. Panel nuts made of metal may be stamped and formed into the shape of a C or a U. The C or U-shape and a spring force created by the shape of panel nuts allow the panel nuts to be installed on relatively thin substrates, such as a panel. The spring force provides a small clamp load onto the panel to maintain the position of the panel nut on the panel. However, when installed onto a panel, the clamp load alone is often insufficient to maintain the position of the panel nut on the panel. This results in that the panel nut may move from its location on the panel during handling or moving the panel prior to inserting a threaded fastener.

Accordingly, there exists a need for an improved panel nut that better maintains its position on the article to which it is installed in advance of securing a threaded fastener to the panel nut.

### SUMMARY

In one embodiment, a panel nut includes an upper arm, a lower arm, and at least one transition arm extending between the upper arm and the lower arm to allow the upper arm to elastically deflect with respect to the lower arm. The upper arm includes a forward flange, an inner member having a first end and an opposite second end, at least one outer member having a first end and an opposite second end, and a thread housing having a fastener aperture formed therein, the thread housing formed on the inner member. The first end of the inner member and the first end of the outer member extend from the forward flange. The transition arm extends between the second end of the outer member of the upper arm and the rear end of the lower arm. The lower arm includes a forward edge, an opposite rear end, a retainer hinge, and a retainer extending from the retainer hinge toward the rear end and toward the upper arm, the retainer having a retainer aperture formed therein. The retainer is configured to elastically deflect between an unstressed position and a stressed position. The retainer is at least partially received within the thread housing when in the unstressed position and the retainer does not extend within the thread housing when in the stressed position.

In another embodiment, a panel nut includes an upper arm, a lower arm, and a pair of transition arms extending between the upper arm and the lower arm to allow the upper arm to elastically deflect with respect to the lower arm. The upper arm includes a forward flange, an inner member having a first end and an opposite second end, a pair of outer members having a first end and an opposite second end, and a thread housing having a fastener aperture formed therein, the thread housing formed on the inner member. The first end of the inner member and the first end of the outer members extend from the forward flange. The lower arm includes a forward edge, an opposite rear end, a retainer hinge, and a retainer extending from the retainer hinge toward the rear end and toward the upper arm, the retainer having a retainer aperture formed therein. The transition arms extend between the second end of each outer member of the upper arm and the rear end of the lower arm. The retainer elastically deflects between an unstressed position and a stressed position. The retainer is at least partially received within the thread housing when in the unstressed position and the retainer does not extend within the thread housing when in the stressed position.

In yet another embodiment, a panel nut includes an upper arm, a lower arm, and a pair of transition arms extending between the upper arm and the lower arm to allow the upper arm to elastically deflect with respect to the lower arm. The upper arm includes a forward flange, an inner member having a first end and an opposite second end, a pair of outer members having a first end and an opposite second end, and a thread housing having a fastener aperture formed therein, the thread housing formed on the inner member. The first end of the inner member and the first end of the outer members extend from the forward flange. The lower arm includes a forward edge, an opposite rear end, a retainer hinge, and a retainer extending from the retainer hinge toward the rear end and toward the upper arm, the retainer having a retainer aperture formed therein. The retainer aperture aligns with the fastener aperture and the retainer hinge is a recess formed in the lower arm. The transition arms extend between the second end of each outer member of the upper arm and the rear end of the lower arm. The retainer elastically deflects between an unstressed position and a stressed position. The retainer is at least partially received within the thread housing when in the unstressed position and the retainer does not extend within the thread housing when in the stressed position.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a top rear perspective view of a panel nut;

FIG. 2 schematically depicts a top front perspective view of the panel nut of FIG. 1;

FIG. 3 schematically depicts a top view of the panel nut of FIG. 1;

FIG. 4 schematically depicts a side view of the panel nut of FIG. 1;

FIG. 5 schematically depicts a bottom view of the panel nut of FIG. 1;

FIG. 6 schematically depicts a perspective view of the panel nut showing a cross-section of FIG. 1;

FIG. 7 schematically depicts a cross-sectional view of the panel nut taken along line 7-7 of FIG. 2;

FIG. 8 schematically depicts a side view of the cross-section of the panel nut of FIG. 7 with an article positioned in the panel nut when in a stressed position; and

FIG. 9 schematically depicts a side view of the cross-section of the panel nut of FIG. 7 with an article positioned in the panel nut when in an unstressed position.

### DETAILED DESCRIPTION

Embodiments described herein are directed to an improved panel nut that solves the problem of insufficient retention of a panel nut on an article or substrate, such as a panel.

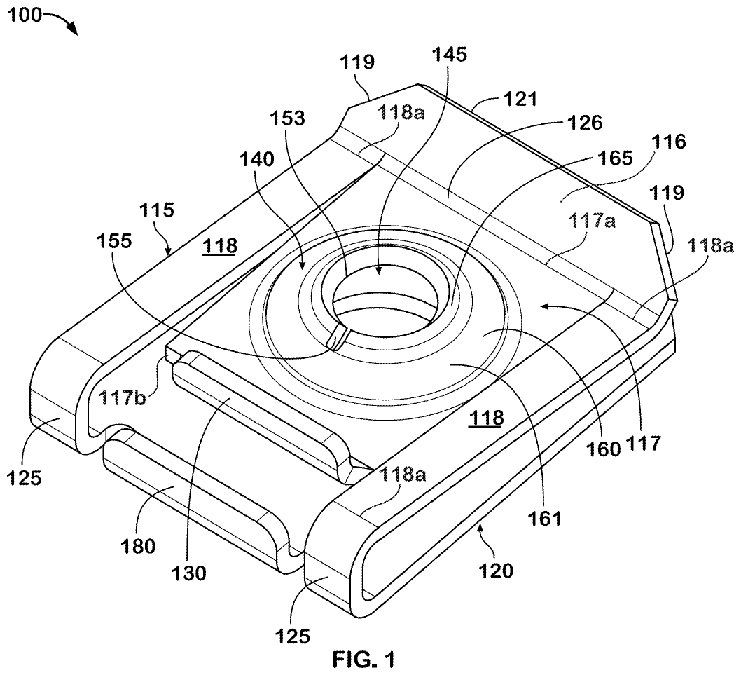

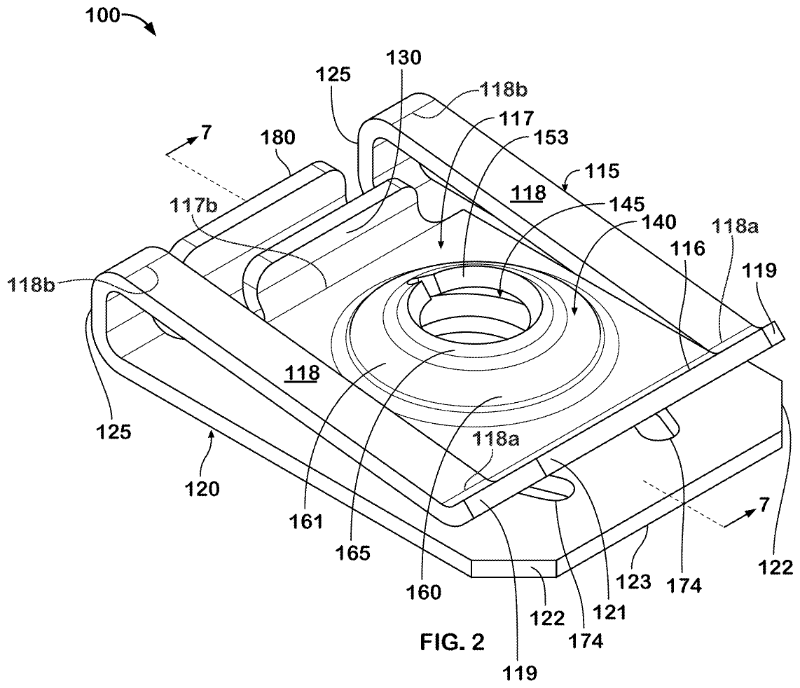

Turning to the drawings, FIGS. 1 and 2 illustrate an embodiment of an improved panel nut 100 that provides improved retention to an article to which it is fastened. In this embodiment, panel nut 100 includes an upper arm 115, a lower arm 120, and a pair of transition arms 125 extending between the upper arm 115 and the lower arm 120. As such, the transition arms 125 extend downwardly from the upper arm 115 and connect to a respective lower arm 120. Throughout the ensuing description, the upper arm 115 is referred to as being above the lower arm 120 for purposes of describing an “upward” direction or a “downward” direction. As shown, the upper arm 115 includes a pair of outer members 118. However, it is to be appreciated that, in some embodiments, the upper arm 115 includes only one outer member 118. When only a single outer member 118 is provided, only a single transition arm 125 may be provided to extend between the upper arm 115 and the lower arm 120.

The panel nut 100 may be made from, for example, sheet metal. In other embodiments, the panel nut 100 may be made from a plastic, a composite, or any other suitable material. The panel nut 100 may be fabricated using conventional methods, including stamping, embossing, cutting, including laser cutting, and folding via tool and die forming methods.

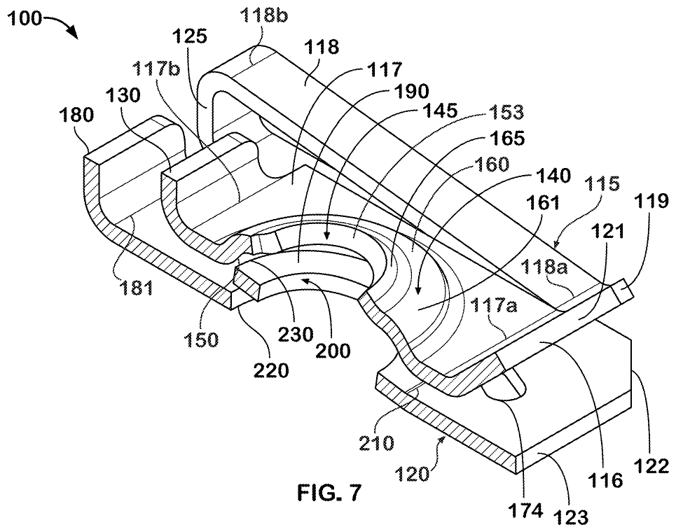

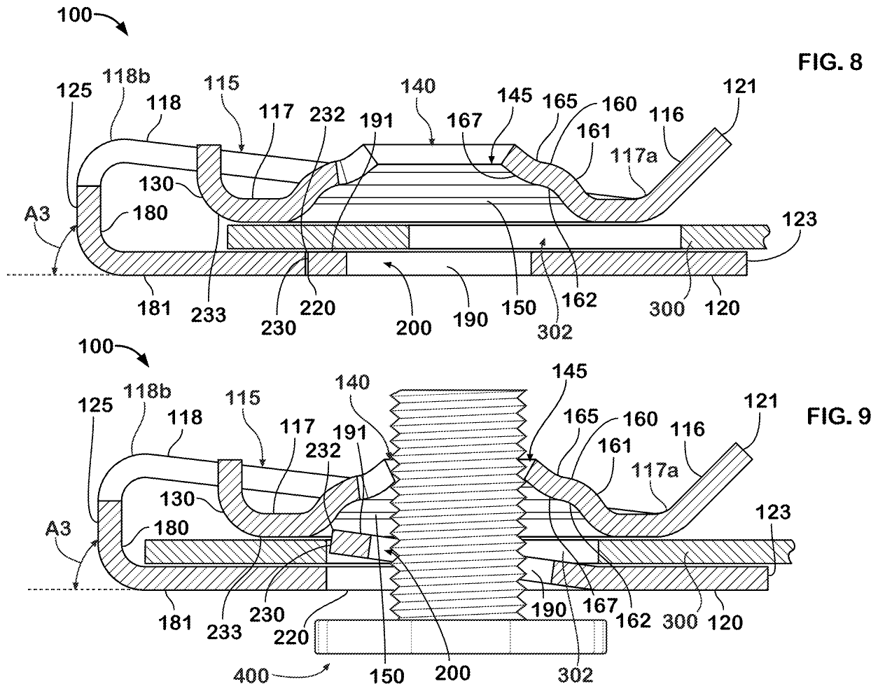

The upper arm 115 includes a forward flange 116, an inner member 117, and the pair of outer members 118 having a first end 118a and an opposite second end 118b. The inner member 117 includes a forward or first end 117a and an opposite rear or second end 117b. The inner member 117 includes a thread housing 140, a retainer recess 150 (FIGS. 7 and 8), and a middle flange 130. The thread housing 140 includes a thread 153 defining a fastener aperture 145, a thread relief 155, and an S-shaped, double conical wall 160. The thread relief 155 is a notch formed in the conical wall 160 extending inwardly from the thread 153. The fastener aperture 145, the thread 153, and the thread relief 155 cooperate to receive a threaded fastener 400 (FIG. 8), such as a screw or a bolt, for securing the panel nut 100 to an article to be fastened. The conical wall 160 includes a lower bulbous cone 161 and an upper cone 165. Throughout the ensuing description, the forward flange 116 is referred to as being forward of the transition arms 125 for purposes of describing a “forward” direction or a “rearward” direction.

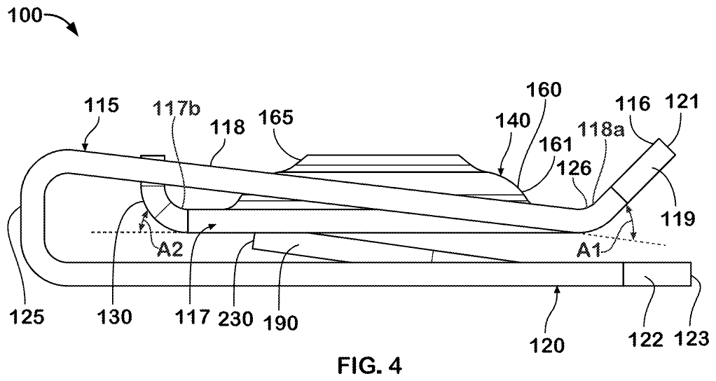

Referring to FIG. 4, the pair of outer members 118 extend forwardly and downwardly from the transition arms 125 and connect to the forward flange 116 via a transition 126 at the first end 117a of the inner member 117. The forward flange 116 extends from the transition 126 forwardly opposite the transition arms 125 and upwardly opposite the lower arm 120 at an angle A1. In some embodiments, the angle A1 at which the forward flange 116 extends from the inner member 117 and the outer members 118 ranges from 20° to 60°. In some embodiments, the angle A1 at which the forward flange 116 extends from the inner member 117 and the outer members 118 ranges from 30° to 50°. In some embodiments, the angle A1 at which the forward flange 116 extends from the inner member 117 and the outer members 118 ranges from 40° to 50°. In some embodiments, the angle A1 at which the forward flange 116 extends from the inner member 117 and the outer members 118 is 45°±5°. In other embodiments, the angle A1 may be any other suitable angle for assisting the user to install the panel nut 100 onto an article to be fastened.

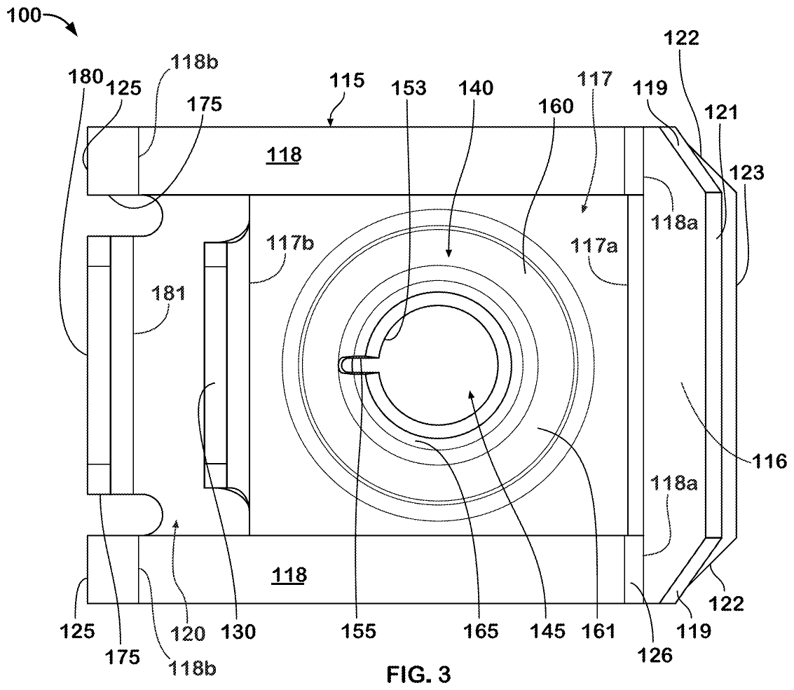

Referring to FIGS. 1-4, the forward flange 116 includes a pair of opposed corner chamfers 119 along a forward edge 121 opposite the outer members 118 for ease of installation of panel nut 100 onto an article to be fastened. The inner member 117 extends rearwardly and generally horizontally from the transition 126 toward the transition arms 125 and connects to the middle flange 130. Referring to FIG. 4, the middle flange 130 extends upwardly opposite the lower arm 120 from the second end 117b of the inner member 117 at an angle A2 relative to the inner member 117 and improves the rigidity and strength of the inner member 117. In some embodiments, the angle A2 at which the middle flange 130 extends upwardly from the inner member 117 ranges from 45° to 135°. In some embodiments, the angle A2 at which the middle flange 130 extends upwardly from the inner member 117 ranges from 70° to 110°. In some embodiments, the angle A2 at which the middle flange 130 extends upwardly from the inner member 117 is 90°±5°. In other embodiments, the angle A2 may be any other suitable angle for assisting the user to install the panel nut 100 onto an article to be fastened.

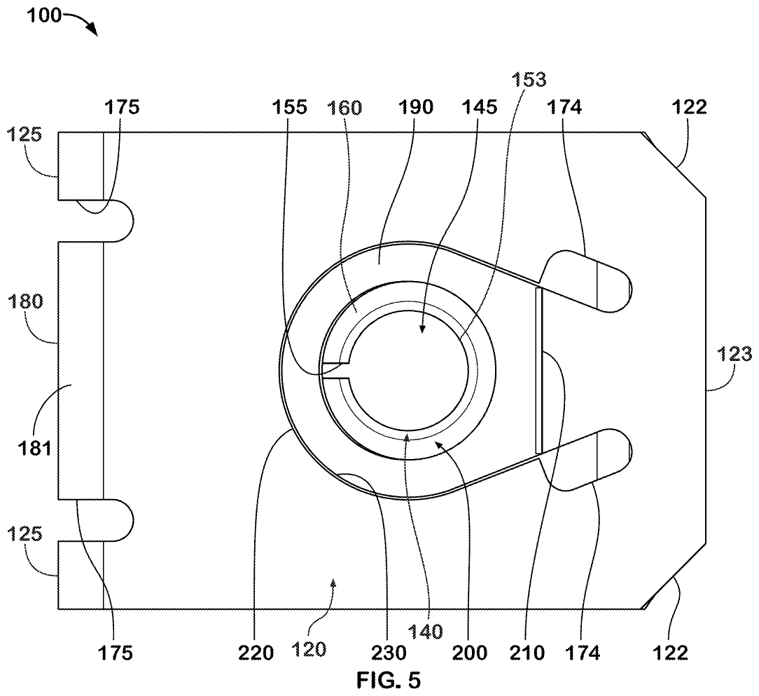

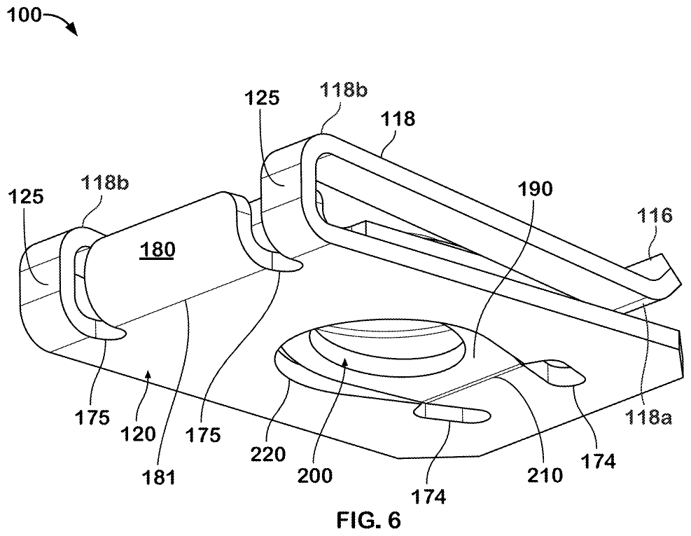

As shown in FIGS. 4-6, the lower arm 120 also includes a rear flange 180, a retainer 190 defining a retainer aperture 200, a pair of relief slots 174, at least one rear slot 175, a retainer hinge 210, and a retainer slot 220 separating the retainer 190 from the lower arm 120. The lower arm 120 extends forwardly away from the transition arms 125 and generally horizontally with respect to the inner member 117 and is positioned under the inner member 117 and the outer members 118 of the upper arm 115. The lower arm 120 includes a pair of opposed corner chamfers 122 along a forward edge 123. In some embodiments, the retainer hinge 210 may include a biasing member, such as a spring, allowing the retainer 190 to bias with respect to the lower arm 120, as discussed in more detail herein. In some embodiments, the retainer hinge 210 may be defined by a recess formed in the lower arm 120 at a point at which the retainer 190 is joined to the lower arm 120 between the relief slots 174.

The rear flange 180 extends upwardly from a rear end 181 of the lower arm 120 at an angle A3 (FIG. 8) between respective outer members 118. In some embodiments, the angle A3 at which the rear flange 180 extends upwardly from the rear end 181 ranges from 45° to 135°. In some embodiments, the angle A3 at which the rear flange 180 extends upwardly from the rear end 181 ranges from 70° to 110°. In some embodiments, the angle A3 at which the rear flange 180 extends upwardly from the rear end 181 is 90°±5°. In other embodiments, the angle A3 may be any other suitable angle for assisting the user to install the panel nut 100 onto an article to be fastened. In this embodiment, the retainer slot 220 is configured with an arcuate profile to form the retainer 190 having an arcuate retainer wall 230. In other embodiments, the retainer slot 220 and, thus, the retainer 190, may have any suitable geometry.

As shown in FIGS. 7-9, the panel nut 100 is configured to receive an article 300 to be fastened between the upper arm 115 and the lower arm 120. During insertion, as shown in FIG. 8 when in the stressed position, the upper arm 115 may be configured to deflect slightly upwardly away from the lower arm 120 via the transition arms 125 to allow the article 300 to slide between the inner member 117 of the upper arm 115 and the lower arm 120. In this way, the transition arms 125 act as a spring to allow the inner member 117 of the upper arm 115 and the lower arm 120 to provide a clamp load on the article 300. It should be appreciated that the inner member 117 moves independently of the outer members 118.

At the same time, in the stressed position, as shown in FIG. 8, the retainer 190 is configured to elastically deflect downwardly and away from the upper arm 115 via the retainer hinge 210 to allow the article 300 to slide between the inner member 117 of the upper arm 115 and the lower arm 120. The article 300 includes a fastener hole 302 that is configured to align with the fastener aperture 145, which is coaxial with the retainer aperture 200. Thus, when the fastener hole 302 is aligned with the fastener aperture 145 and the retainer aperture 200, the retainer 190 is configured to elastically return to its permanently deformed positioned, i.e., an unstressed position, as shown in FIG. 9. To retain the article 300 between the upper arm 115 and the lower arm 120, the arcuate retainer wall 230 of the retainer 190 is configured to lie within the fastener hole 302 of the article 300. As such, the retainer 190 is configured to capture and retain the article 300 when positioned between the inner member 117 of the upper arm 115 and the lower arm 120. Therefore, the retainer 190 is configured with a sizeable permanent deflection formed relative to the lower arm 120. The sizeable permanent deflection of the retainer 190 permits the retainer 190 to firmly and positively engage the fastener hole 302 of the article 300 to prevent the panel nut 100 from sliding off of the article 300.

To provide the sizable permanent deflection of the retainer 190 at the retainer hinge 210, the thread housing 140 is configured with the double conical wall 160 to form the retainer recess 150. The retainer recess 150 provides clearance for the retainer 190 to be significantly deflected to cause the retainer 190 to retain a sizable permanent angle relative to the lower arm 120. As shown in FIG. 9, when in the unstressed position, at least a portion of an upper arcuate edge 232 defined by the arcuate retainer wall 230 and an upper retainer wall 191 of the retainer 190 is configured to be received within the thread housing 140 and lie above a bottom wall 233 of the inner member 117. The double conical wall 160 having the lower bulbous cone 161 defining a circumference 162 of the retainer recess 150 provides the internal clearance necessary to permanently deform the retainer 190 to such a large degree. The double conical wall 160 having the upper cone 165 defining a circumference 167 causes the fastener aperture 145 and the thread 153 to be positioned above the retainer recess 150 and at a greater distance away from the lower arm 120. This provides additional clearance for permanent deflection of the retainer 190. As shown, the circumference 162 of the lower bulbous cone 161 is greater than the circumference 167 of the upper cone 165. As such, the lower bulbous cone 161 has a diameter greater than a diameter of the upper cone 165. In some embodiments, the thread 153 lies on an angular, circular wall defined by the upper cone 165, the circumference 167, and the fastener aperture 145.

To aid in installation, the middle flange 130 and the rear flange 180 may be configured with relatively long flanges to reduce a user's installation finger pressure and, therefore, the user's installation fatigue. A middle flange 130 and the rear flange 180 reduce installation finger pressure by spreading the installation force over relatively longer flange lengths. The outer members 118 enable the middle flange 130 and the rear flange 180 to span the distance between respective outer members 118. In some embodiments, each of the respective outer members 118 ranges from 10% to 20%±5° of the width of the lower arm 120 of the panel nut 100. In some embodiments, each of the respective outer members 118 is 15%±5° of the width of the lower arm 120 of the panel nut 100. In some embodiments, the middle flange 130 and the rear flange 180 each range from 40% and 60%±5° of the width of the lower arm 120. In some embodiments, the middle flange 130 and the rear flange 180 each range from 50% to 55%±5° of the width of the lower arm 120. Consequently, the middle flange 130 and the rear flange 180 may each be at least 50%±5° of the width of lower arm 120. The rest of the width of the lower arm 120 is occupied by at least one rear slot 175 adjacent a respective lateral end of the rear flange 180 and the at least one transition arm 125. In other embodiments, these widths may be any number of different percentages to make the rear slots 175 wider or narrower or to make the middle flange 130 and/or the rear flange 180 longer or shorter. Likewise, in other embodiments, the vertical height of middle flange 130 and rear flange 180 may be taller or shorter than as illustrated in the figures depending on the length of the stock from which the panel nut 100 is cut, the longitudinal placement of the thread housing 140, and/or the vertical height of the transition arms 125.

While particular embodiments have been illustrated and described herein, it should be understood that various other changes and modifications may be made without departing from the scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A panel nut comprising:
an upper arm including a forward flange, an inner member having a first end and an opposite second end, at least one outer member having a first end and an opposite second end, and a thread housing having a fastener aperture formed therein, the thread housing formed on the inner member, the first end of the inner member and the first end of the outer member extending from the forward flange;
at least one transition arm extending between the second end of the outer member of the upper arm and the rear end of the lower arm to allow the upper arm to elastically deflect with respect to the lower arm; and
a lower arm including a forward edge, an opposite rear end, and a retainer extending from the retainer hinge toward the rear end and toward the upper arm, the retainer having a retainer aperture formed therein, the retainer configured to elastically deflect between an unstressed position and a stressed position.

2. The panel nut of claim 1, wherein the transition arm permits the upper arm to elastically deflect with respect to the lower arm.

3. The panel nut of claim 1, further comprising a retainer hinge, the lower arm including a pair of relief slots formed on opposite sides of the retainer hinge.

4. The panel nut of claim 1, wherein the retainer is at least partially received within the thread housing when in the unstressed position, and wherein the retainer does not extend within the thread housing when in the stressed position

5. The panel nut of claim 1, wherein the lower arm further comprises at least one rear slot formed in the rear end of the lower arm and adjacent the transition arm, and a rear flange extending from the rear end of the lower arm, the rear slot formed between the transition arm and the rear flange, the rear flange is at least 50% of a width of the lower arm.

6. The panel nut of claim 1, wherein the forward flange extends at an angle within a range of 40° to 50° with respect to the inner member.

7. The panel nut of claim 1, wherein the inner member includes a middle flange extending from the second end of the inner member and opposite the lower arm.

8. The panel nut of claim 7, wherein the middle flange is at least 50% of a width of the lower arm.

9. The panel nut of claim 1, wherein the thread housing comprises an upper cone and a lower bulbous cone, the upper cone defining a thread and the lower bulbous cone defining a recess for receiving the retainer when in the unstressed position.

10. The panel nut of claim 9, wherein the thread housing has a thread relief formed therein and extending from the thread toward the lower bulbous cone.

11. The panel nut of claim 1, wherein the retainer aperture is aligned with the fastener aperture to permit a threaded fastener to extend therethrough.

12. A panel nut comprising:
an upper arm including a forward flange, an inner member having a first end and an opposite second end, a pair of outer members having a first end and an opposite second end, and a thread housing having a fastener aperture formed therein, the thread housing formed on the inner member, the first end of the inner member and the first end of the pair of outer members extending from the forward flange;
a lower arm including a forward edge, an opposite rear end, a retainer hinge, and a retainer extending from the retainer hinge toward the rear end and toward the upper arm, the retainer having a retainer aperture formed therein; and
a pair of transition arms extending between the second end of each outer member of the upper arm and the rear end of the lower arm to allow the upper arm to elastically deflect with respect to the lower arm,
wherein the retainer elastically deflects between an unstressed position and a stressed position, the retainer is at least partially received within the thread housing when in the unstressed position, the retainer does not extend within the thread housing when in the stressed position.

13. The panel nut of claim 12, wherein the lower arm includes a pair of relief slots formed on opposite sides of the retainer hinge.

14. The panel nut of claim 12, wherein the forward flange extends at an angle within a range of 40° to 50° with respect to the inner member.

15. The panel nut of claim 12, wherein the thread housing comprises an upper cone and a lower bulbous cone, the upper cone defining a thread and the lower bulbous cone defining a recess for receiving the retainer when in the unstressed position.

16. The panel nut of claim 15, wherein the thread housing has a thread relief formed therein and extending from the thread toward the lower bulbous cone.

17. The panel nut of claim 15, wherein the upper cone has a first diameter and the lower bulbous cone has a second diameter, the second diameter being greater than the first diameter.

18. A panel nut comprising:
an upper arm including a forward flange, an inner member having a first end and an opposite second end, a pair of outer members having a first end and an opposite second end, and a thread housing having a fastener aperture formed therein, the thread housing formed on the inner member, the first end of the inner member and the first end of the pair of outer members extending from the forward flange;
a lower arm including a forward edge, an opposite rear end, a retainer hinge, and a retainer extending from the retainer hinge toward the rear end and toward the upper arm, the retainer having a retainer aperture formed therein, the retainer aperture aligning with the fastener aperture, the retainer hinge being a recess formed in the lower arm; and
a pair of transition arms extending between the second end of each outer member of the upper arm and the rear end of the lower arm to allow the upper arm to elastically deflect with respect to the lower arm,
wherein the retainer elastically deflects between an unstressed position and a stressed position, the retainer is at least partially received within the thread housing when in the unstressed position, the retainer does not extend within the thread housing when in the stressed position.

19. The panel nut of claim 18, wherein the inner member includes a middle flange extending from the second end of the inner member and opposite the lower arm, the middle flange is at least 50% of a width of the lower arm.

20. The panel nut of claim 18, wherein the lower arm further comprises a pair of rear slots formed in the rear end of the lower arm and adjacent a respective one of the transition arms, and further includes a rear flange extending from the rear end of the lower arm between the pair of rear slots, the rear flange being at least 50% of a width of the lower arm.
